(19) United States
(12) Patent Application Publication
(10) Pub. No.: US 2008/0285814 A1
(43) Pub. Date: Nov. 20, 2008

(54) Independent third party real time identity and age verification process employing biometric technology

(76) Inventors: James Martin Di Carlo, Katy, TX (US); Howard Curtis Peace, Houston, TX (US); Kyle Lin Peace, Houston, TX (US)

Correspondence Address: Jim Di Carlo, 711 Endell Ct, Katy, TX, 77450, US

(21) Appl. No.: 11/798,952

(22) Filed: May 18, 2007

(51) Int. Cl. G06K 9/00; G06Q 20/00

(52) U.S. Cl. 382/115; 705/16

(57) ABSTRACT

A physically and technologically secured Network Operating Center (NOC), which collects physiological samples, including but not limited to fingerprints, voice prints, DNA samples and retina scans and commonly known information including but not limited to name, date of birth and social security number on a plurality of individuals and storing said samples and information on scalable enterprise data clusters; by request through technological means from a plurality of entities to include but not limited to corporations, retailers, financial institutions, government agencies and/or individuals, the data clusters will compare stored physiological sample(s) to the entity's supplied sample(s) for verification of match, furthermore, date of birth for matched physiological sample can be transmitted.

### CROSS REFERENCE

This application is a continuation of a provisional Patent Application, application No. 60/800,425

### FIELD OF INVENTION

This invention relates generally to a computer system that transmits on demand by the individual, biometric sample data of the same individual for comparison in a secured NOC database, which responds based after successful comparison with either the name and/or age of individual or a null statement.

### BACKGROUND OF INVENTION

The present invention relates to the identification and/or age of an individual.

Identity theft is a multi-billion dollar problem. State and Federal authorities have stated that identity theft is the fastest growing white-collar crime since the 1990's. Identity theft occurs in a multitude of ways, stealing a wallet or purse, intercepting the mail, telephone scams, e-mail scams (phishing), viruses/worms (pharming), hackers and forgery.

Referencing a report prepared by Synovate for the Federal Trade Commission in 2003. 9.91 million people were victims to identity theft. The cost to financial institutions and individuals totaled $52.6 billion dollars for the year. The individual spent 297 million hours correcting the damage caused by identity theft; using an average annual income of $20,000, an additional $3.08 billion dollars lost. Without proper data, a reasonable calculation cannot be obtained as to what percentage of the $3.08 billion can be charged to the employer for lost productivity of the individual.

Since 911 and our vulnerability within the transportation industry has become apparent. Homeland Security has placed the identification of travelers as a priority in order to minimize the potential of terrorist accessing our commercial airliners.

Another problem area is in internet chat rooms, ‘Facebook’ and ‘Myspace’. Pedophiles enter youth oriented web-sites using false identities and ages, so they gain opportunity to approach young children and teenagers.

Identity verification is a priority demand by businesses, government and the general public. It is this demand that has produced a large number of programs to assist in identity theft. These programs range from smart card technology incorporating biometric technology to stand alone biometric scanning systems.

Existing patents relating to biometric technology make claim of identity verification of an individual as a method to control identity theft. Their application of the technology is based on a one to one to one protocol solution (one solution, one problem, one user); the invention (one solution) resolves identity theft (one problem) by working with an individual entity (one user) engaged in identity theft prevention. Furthermore database integrity is tantamount for accurate identity verification. In the one to one to one protocol, each end user will create a unique database. Each database will be built employing standards set by the end user, which include but not limited to technical knowledge, value placed on database integrity, protocols established for communications between the database and scanners, and method(s) of data collection. Finally, individuals will be required to register with each database system on an as needed basis making the process cumbersome to the individual.

Other patents relating to biometric technology make claim of identity verification through means of a ‘smart card’ or similar type of data storage tokens. With the inclusion of the aforementioned issues, the token maintains a drawback of duplication. Technology currently exist allowing for reprogramming, reformatting and/or creating a false token with biometric data of one individual and the name of another individual.

### OBJECTIVES OF INVENTION

It is the objective of this invention to verify the identity and/or age verification of an individual upon demand by the individual through means of submitting a biometric sample and user identification number via a biometric scanner, a data input device and display device with a secure internet connection. It is another objective of this invention to allow the individual to verify identity and/or age verification on demand without the use of a token, i.e. smart card. It is another objective to allow the individual to enroll once into the system and allow the individual to prove their identity and/or age to any entity with the proper technology in place at point of demand.

It is a further objective of the invention to address the identity security and age verification through a one to many to many protocol system, one solution, many problems, many users. The invention, one solution; identity verification and age verification, many problems; multiple individuals, many users.

It is a further objective of the invention that a primary NOC and back up NOC (redundancy protocol) will be installed in secure locations. Each installation shall include but not limited to, solid wall construction (CMU brick reinforced with a concrete fill, tilt-wall or similar type construction). Each penetration point into the installation will maintain one or more security features including but not limited to motion sensors, infrared devices and cameras. The installations shall be self-contained in regards to environmental services and controls, power back up to include but not limited to battery and gas generators. All points of designed access/egress will include one or more security features to include but not limited to security guard, biometric scanning of voice, eye, fingerprint and DNA. All areas internally and externally of the NOC, will be monitored with such devices as to include but not limited to motion, heat and sound sensors, infrared and standard video with audio capabilities. Caveat, the integrity of the database housed within the NOC is tantamount for accurate verification of third party physiological sample(s), therefore inventors will if deemed necessary incorporate any and all security technology procedures currently available or available in the future, unknown to them at this time.

It is another objective of the invention that the Network Operating Center (NOC) is comprised of six (6) sub-systems:
1. Sub-system 1 (SS1) Off-Site Data Collection (FIG. 2.)
2. Sub-system 2 (SS2) Data Storage (FIG. 3.)
3. Sub-system 3 (SS3) Open Request (FIG. 4.)
4. Sub-system 4 (SS4) Sample Verification (FIG. 5.)
5. Sub-system 5 (SS5) Transactional Logging (FIG. 6.)
6. Sub-system 6 (SS6) System Maintenance (FIG. 7.)

The technological security of the sub-systems within the NOC will be placed on the front and back end of each sub-system and web application, these security measures will include but not limited to firewalls, routers, portal redirects and authentication procedures.

It is another objective of the invention that Off-Site Data Collection (SS1) is designed to accept secure/encrypted authenticated input from remote Data Collection Center (DCC) locations. Each DCC will be equipped with one or more biometric scanners capable of extracting one or more physiological sample(s) to include but not limited to fingerprints, voice, retina and DNA of a plurality of individuals. In addition, the DCC will be further equipped to manually input commonly known data (CKD) to include but not limited to name, date of birth and social security number of a plurality of individuals via keypad. The SS1 will communicate with the DCC via a secured web-based Internet connection. The SS1 will host a server driven program allowing the SS1 to retrieve the acquired sample(s) and CDK from the DCC without allowing the DCC access to any operating environments within the NOC. Upon retrieval of sample(s) and data the SS1 server driven program will erase any and all cached memory of the transaction from the DCC. Once the transaction is complete, the SS1 will wait for a second transmission from the DCC containing a second physiological sample for comparison to the first sample received; this is a data quality protocol. Once the data quality protocol is complete, the SS1 will transfer the sample and data to the Sample Verification sub-system 4 (SS4). The communication protocol will be unidirectional data flow from SS1 to SS4. The SS4 will compare the sample with all existing samples on the Data Storage sub-system (SS2). If the sample is unique, it will transfer the sample and all data collected to the SS2 and a new database read only entry is created. If a duplicate is found, the account on record and new information will be logged on to the Transactional Log sub-system (SS5) and an alert will be forwarded to the DCC.

It is a further objective of the invention that the Data Storage sub-system (SS2) will house the physiological sample(s) and CDK. The SS2 will be a scalable clustered database server array constructed on a fail over, fail back protocol in addition to a roll over protocol. The SS2 will maintain a bi-directional dataflow protocol only with the Sample Verification sub-system (SS4). The SS4 will request from the SS2 a read-only specific physiological sample based on a specific data item within the CKD (“Identifier”). The sample will be read by the SS4 for the actual sample verification process.

It is a further objective of the invention that the Open Request sub-system (SS3) will be a secured web portal allowing authorized remote third party entities and individuals (Entities), as defined earlier, to request a physiological sample comparison. The Entities will be equipped with a specifically designed, engineered and built biometric scanner and keypad and/or a stand-alone biometric scanner which can be connected to a laptop or desktop computer (collectively or individually known as “scanner”). The Entity will input the Identifier of an individual into the scanner, the individual associated with the Identifier will input a physiological sample into the scanner, if at the option of Entity, type of financial resource to be used, which includes but not limited to credit card issuers, financial institutions, and personal check and/or request for birth date. Upon all data being entered and submitted, scanner will transmit data packet consisting of, a scanner unique identification code, the Identifier, physiological sample, and/or financial resource to be used and/or a request for birth date. Upon receipt of data packet, SS3 will submit a query to the Sample Verification sub-system (SS4) for physiological sample verification. SS4 will notify SS3 of the result. If the result is a positive match, SS3 will submit to Entity, name on account and if requested date of birth on account. If a mismatch, SS3 will allow entity to retry or terminate verification process. A total of three (3) attempts will be allowed, at which time the SS4 will notify SS3 of termination of verification process.

It is a further objective of the invention that the Sample Verification sub-system (SS4) will be a scalable clustered processing server array constructed with fail over/fail back protocol and roll over protocol. The SS1 will submit to the SS4, an Identifier for a specific database file and a physiological sample. The SS4 will search for a duplication of the Identifier and physiological sample on the SS2 database. If there is no duplication, the SS4 will transfer all CKD data and physiological sample(s) to the SS2, where a new database read only entry is created. In addition, SS3 will request verification of physiological sample(s), optionally a date of birth on the account and submit an Identifier, date/time stamp of the request, unique identifier of the scanner used and optionally the financial resource to be used. The SS4 will retrieve the physiological sample from the SS2 account corresponding to the Identifier supplied. A comparison of the SS2 and SS3 samples will be made. In the event that the comparison is a match, SS4 will complete the transaction, which includes a log entry into the Transactional Log sub-system (SS5), the entry will include date/time stamp, financial resource used, scanner unique identification code and Identifier. In addition, SS4 will respond to SS3 with a positive confirmation of verification of name on account and if requested, date of birth. If the comparison is a mismatch, the SS4 will notify SS3 of result requesting SS3 to retry or terminate verification process and submit a transactional log to the SS5 containing date/time stamp, Identifier, credit resource intended for use and/or date of birth on account. If in the event the verification is attempted and failed for a third time, the SS4 will terminate the verification process.

It is a further objective of the invention that the Transactional Log sub-system (SS5) will be a combination processing and data file server. The SS4 will submit during every verification transaction a log report based on outcome of verification process as described above. In the event of a mismatch log, the SS5 will keep an active count on the retries for the verification transaction; if and when three (3) retries have been made, SS5 will notify SS4 to terminate transaction. Additionally, an alert will be forwarded to the financial resource on transaction of the failed attempts. Further, on a regular schedule, the SS5 will sort the log entries by scanner, financial resource used, Identifier and date/time stamp. The sort will be used for billing and reporting services to clients.

It is a further objective of the invention that the System Maintenance sub-system (SS6) is self explanatory, the functions of this sub-system include but not limited to, scheduled database integrity checks, scheduled secured database backups, network security real time monitoring, real time network and cluster failure monitoring and scheduled software revision testing.

It is a further objective of the invention that the biometric scanner will come in four (4) variations. 1. Data Collection consisting of a biometric scanner that will be connected to a workstation within the DCC. All keypad entries will be made from the workstation keyboard. Any response or request for information from the NOC will be viewed on the monitor attached to the workstation. The biometric scanner may or may not include the capability of acquiring an entire handprint. 2. The Public Sector Scanner will be constructed to incorporate a keypad and LCD display. The consumer will input onto the keypad their Identifier choice of identity and/or age verification, upon completion of input, the consumer will place thumb onto scanner. The scanner is pressure activated and will immediately commence scanning sequence. Once scan is complete, consumer will press the send key or similar type command key. The LCD will display results of the NOC verification process. 3. The Public Age Verification scanner is a hand held device that may or may not be a wireless connection, it will incorporate a LCD screen, keypad and a biometric scanner. The consumer will input Identifier and place thumb on scanner. Upon scan completion, the send or similar command is executed. The LCD will display date of birth. 4. The Household scanner will be a biometric scanner attached to the individual's laptop and/or desktop computer, thus utilizing the monitor and keyboard peripherals connected to the computer. The functions are similar to those of the aforementioned scanners. Prior to installation, all household members will need to establish an identity record at the NOC; this is accomplished by furnishing required CKD and a biometric sample at any DCC near them. At time of installation, the individual(s) within the household will submit their Identity and biometric sample into the scanner, the scanner will make an identity verification, upon successful verification the scanner unique identification code will be transmitted to the NOC and entered into the individual's record on the database at the NOC. This is a one time only registration and cannot be modified. In the event of change within the household, including but not limited to marriage, family addition or divorce, the individual may exchange the Household scanner for a new Household scanner, which can then be registered to reflect the changes within the household. Each time the Household scanner is accessed, the NOC will verify that the individual is authorized to engage in e-commerce or seek age verification with the Household scanner.

It is a further objective of the invention that all variations of the biometric scanning devices will have a unique identification code, which is embedded within the unit. Every time a data packet is forwarded to the NOC, the unique identification code along with a date/time stamp will be included within the bit stream

### SUMMARY OF INVENTION

Herein described is a biometric identity and age verification system. The system being designed to render an independent third party verification of an individual's name and/or date of birth to any other individual and/or entity requesting the verification.

The present invention includes a Network Operating Center (NOC) that will communicate through secure internet connections to an array of biometric scanners and data input devices.

Also in the present invention, the NOC will allow only the Data Collection Center to upload information. The information will include biometric sample(s), commonly known individual information, name, date of birth and social security number and/or passport identification number.

Also in the present invention, all other biometric scanners and data input devices will upload to a secure web site, user identification number and biometric sample(s). The web site will query the NOC for sample verification.

The present invention satisfies current needs of the individual and entities doing business with individuals with regards to verification of identity and age. Through secured independent third party verification, an individual attempting to exploit another's age or financial resources will not be confirmed as the individual they claim to be. It will be the business entity or individual seeking to do business with the fraudulent individual if they will terminate the transaction. Thus allowing some type of recourse for the individual, who's identity was fraudulently exploited and/or the financial institution who's resources were used on behalf of the exploited individual.

Also in the present invention it further satisfies the need of age restricted web site, chat rooms, ‘Facebook’ and ‘Myspace’. As stated earlier, through a secured independent third party verification, an individual attempting to create a false identity and age to access a restricted site will be denied said account within the NOC thus being barred from accessing age restricted web sites.

Although the invention has been described with respect to a particular computer system and method for its use, it will be appreciated that various modifications of the apparatus and method are possible without departing from the invention, which is defined by the claims set forth below.

1. A process to verify the identity and age of an individual through the use of biometric technology, the process comprising: an array of physically and technologically secured Network Operating Centers (NOC), comprised of data storage clusters which collects through biometric technology, physiological samples, including but not limited to fingerprints, voice prints, DNA samples and retina scans, in addition, through standard data input including but not limited to keyboard, touch screen, PDA device and wireless phone commonly known information including but not limited to name, date of birth and social security number on a plurality of individuals and storing said samples and information on scalable enterprise data clusters; by request through technological means including but not limited to, dial-up, ISDN, broadband, wireless and satellite from a plurality of entities to include but not limited to corporations, retailers, financial institutions, government agencies, e-commerce web sites and/or individuals, the data clusters will compare stored physiological sample(s) to the entity's supplied sample(s) for verification of match, furthermore upon an expanded request, date of birth for matched physiological sample can be transmitted.

2. The method recited in claim 1 wherein the Network Operating Center (NOC) communicates with Data Collection Center(s) (DCC)

3. The method recited in claim 1 wherein the Data Collection Center(s) consist of a standard business class computer, monitor and input device which allows connection of internet access and a biometric scanning device

4. The method recited in claim 1 wherein individual(s) submit biometric samples and commonly known data at the Data Collection Center(s) (DCC).

5. The method recited in claim 1 wherein biometric samples can include but not limited to fingerprint, eye, voice and DNA

6. The method recited in claim 1 wherein commonly known data can include but not limited to full name, date of birth, social security number and passport identification number.

7. The method recited in claim 1 wherein biometric samples and commonly known data are transmitted to the Network Operation Center (NOC)

8. The method recited in claim 1 wherein all submitted biometric sample(s) and commonly known data will be uploaded and compared to existing stored data within the Network Operating Center (NOC). If no existing sample(s) or commonly known data exists, a new record will be made and the Network Operating Center (NOC) will respond to the Data Collection Center that a new record has been established.

9. The method recited in claim 1 wherein, once a record has been established the individual will use an account identifier which may be but not limited to social security number, numeric-birth date (mm/dd/yyyy), computer generated numeric sequence or a biometric sample.

10. The method recited in claim 1 wherein at Point of Sale (POS), including but not limited to retailers, financial institutions, e-commerce web sites, automobile dealerships, restaurants and theaters requiring identity and/or age verification will locate an Identity Scanning Device (ISD) in an appropriate area of their business

11. The method recited in claim 1 wherein an individual(s) required to prove identity and/or age at a Point of Sale (POS) will input account identifier, if the account identifier is not a biometric sample, then individual will also submit a biometric(s) sample into the Identity Scanning Device (ISD).

12. The method recited in claim 1 wherein Identity Scanning Device (ISD) will transmit data to the Network Operating System (NOC).

13. The method recited in claim 1 wherein upon successful upload, the Network Operating System (NOC) will retrieve from the database all biometric samples found which correspond to the account identifier, compare for a positive match

14. The method recited in claim 1 wherein the Network Operating System (NOC) confirms a positive match will transmit the name and birth date of the individual assigned to the matched sample.

15. The method recited in claim 1 wherein the Network Operating System (NOC) does not find a match, will transmit a not registered or similar statement.

16. The method recited in claim 1 wherein Point Of Sale (POS) upon receipt of a name and birth date or not registered statement may conduct business as defined by their established practices based on the response from the Network Operating System (NOC).

17. The method recited in claim 1 wherein Point of Sale (POS) requires documentation of verification for record keeping, the NOC will transmit the transaction report via a method to include but not limited to e-mail, fax and U.S. mail. The verification report will include but not limited to name and date of birth of submitted biometric sample, date and time stamp of verification and Point of Sale (POS).
